(19) United States
(12) Patent Application Publication
(10) Pub. No.: US 2015/0314979 A1
(43) Pub. Date: Nov. 5, 2015

(54) Storage Wrap Material

(71) Applicant: The Procter & Gamble Company, Cincinnati, OH (US)

(72) Inventors: Scott Donald Whalen, Cincinnati, OH (US); Paul Albert Sagel, Maineville, OH (US)

(21) Appl. No.: 14/703,908

(22) Filed: May 5, 2015

Related U.S. Application Data
(60) Provisional application No. 61/988,481, filed on May 5, 2014.

(51) Int. Cl. B65H 35/04; B65H 16/00; C08J 5/18; B65D 65/10

(52) U.S. Cl. CPC B65H 35/04; B65D 65/10; B65H 16/00; C08J 5/18; B65H 16/005; C08J 2323/06; C08J 2423/06; B65H 2701/1944; B65H 2701/1752

(57) ABSTRACT

The present invention relates to sheet-like materials suitable for use in the containment and protection of various items. More particularly, the present invention provides an improved storage wrap material comprising non-porous material, wherein the non-porous material includes a strainable network having a first region and a second region formed of substantially the same material composition, the first region providing a first, elastic-like resistive force to an applied axial elongation, and the second region providing a second distinctive resistive force to further applied axial elongation, thereby providing at least two stages of resistive forces in use.

### FIELD OF THE INVENTION

The present invention relates to sheet-like materials suitable for use in the containment and protection of various items, as well as the preservation of perishable materials such as food items.

### BACKGROUND OF THE INVENTION

Sheet-like materials for use in the containment and protection of various items, as well as the preservation of perishable materials such as food items, are well known in the art. Such materials can be utilized to wrap items individually and/or can be utilized to form a closure for a semi-enclosed container.

### SUMMARY OF THE INVENTION

The present invention provides an improved storage wrap material comprising non-porous material, wherein the non-porous material includes a strainable network having a first region and a second region formed of substantially the same material composition, the first region providing a first, elastic-like resistive force to an applied axial elongation, and the second region providing a second distinctive resistive force to further applied axial elongation, thereby providing at least two stages of resistive forces in use.

The present invention also provides a storage wrap product comprising the storage wrap material described above and a dispenser. The storage wrap material forms a continuous web wound to form a roll of storage wrap material. The roll of storage wrap material is disposed within the dispenser. In one embodiment, the storage wrap product further comprises a core disposed within the dispenser. The sheet of material is wound upon the core to form a roll of storage wrap material. In another embodiment, the dispenser includes a severing apparatus.

In another embodiment, the storage wrap of the present invention comprises a sheet of non-porous material having an average thickness of from about 0.1 mil to about 5.0 mil, the film including:

a. from about 50% to about 90%, by weight of the film, of high-density polyethylene; and

b. from about 10% to about 50%, by weight of the film, of linear low-density polyethylene.

In another embodiment, the storage wrap material of the present invention exhibits a Young's Modulus of less than about 50 MPa, a strain at break of at least about 250%, and a strain at yield of at least about 30%.

The storage wrap materials of the present invention may be utilized to enclose and protect a wide variety of items by various methods of application, including direct application to the desired item, enclosure of the desired item and sealing to itself, and/or sealing the item in combination with a semi-enclosed container.

Such storage wrap materials of the present invention may be advantageously employed in a container system comprising, in combination, the storage wrap material and a semi-enclosed container with at least one opening surrounded by a peripheral edge. The storage wrap material is adhered to the peripheral edge over the opening following activation by a user to convert the semi-enclosed container to a closed container.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a SELF web having a strainable network according to one or more embodiments illustrated and described herein;

FIG. 1A is a segmented, perspective illustration of the SELF web of FIG. 1 in an untensioned condition;

FIG. 1B is a segmented, perspective illustration of the SELF web of FIG. 1 in a tensioned condition;

FIG. 1C is a segmented, perspective illustration of the SELF web of FIG. 1 in a tensioned condition;

FIG. 2 is a graph of the resistive force versus the percent elongation comparing the behavior of the SELF web as shown in FIG. 1 with an otherwise identitcal non-SELF'd web.

FIG. 3 is a simplified side elevational view of an exemplary apparatus used to form the SELF web according to one or more embodiments illustrated and described herein;

FIG. 4 is a plan view of the opposed meshing plates of the exemplary apparatus of FIG. 3 laid side-by-side with their meshing surfaces exposed;

FIG. 5 is a simplied side elevational view of a static press used to form the SELF web according to one or more embodiments illustrated and described herein;

FIG. 6 is a simplified side elevational view of a continuous, dynamic press used to from the SELF web according to one or more embodiments illustrated and described herein;

FIG. 7 is a simplified illustration of an exemplary apparatus used to form the SELF web according to one or more embodiments illustrated and described herein;

FIG. 8 is an illustration of another embodiment of an apparatus used to form the SELF web according to one or more embodiments illustrated and described herein;

FIG. 9 is an illustration of yet another embodiment of an apparatus used to form the SELF web according to one or more embodiments illustrated and described herein.

### DETAILED DESCRIPTION OF THE INVENTION

The storage wrap material of the present invention is preferably provided in the form of a web of flexible material which can be wound upon a core to form a roll which is suitable for use in a dispenser or holder such as carton. If desired, perforations may be provided to facilitate dispensing of pre-measured dimensions of the material in the event that the dispenser, holder, or container does not include a suitable severing apparatus. Manual severing with sharp implements such as knives and scissors may also be accomplished in order to utilize the material in continuous non-perforated form. In alternative storage and dispensing configurations, the storage wrap material may be provided in the form of discrete, pre-measured sheets of uniform or non-uniform dimensions which may be stacked upon one another in any desired sequence and/or orientation and dispensed from a carton, bag, or any other suitable dispensing apparatus. In another alternative storage and dispensing configuration, the storage wrap material may be provided in the form of a continuous web which is Z-folded or pleated and placed in a dispensing carton.

Storage wrap material may be provided with two active sides or surfaces, if desired for particular applications, or alternatively, with only one active side and one inactive or inert side. In another embodiment, the storage wrap material may be provided with two inert sides or surfaces

An active side of the storage wrap material may be selectively activated by a user to provide activated regions where desired to provide selective adhesion of the material to a target surface. The target surface may comprise a separate surface or material, such as a container or an item or items to be wrapped, or may comprise another portion of the storage wrap material itself. Selective activation results in the generation of only so much active area with adhesive properties as is needed, i.e., all remaining portions of the storage wrap material remain inactive or inert. The storage wrap material is therefore capable of forming discrete inactive and active regions on the same side of the material in addition to the ability to have an active side and an inactive side.

Various means of activation are envisioned as being within the scope of the present invention, including, but not limited to compression, extension, and thermal activation. Materials of the present invention exhibit an adhesive, adherent, or tacking character. Accordingly, such materials form a bond or seal when in contact with itself or another target surface. Selectively adherent materials or a pressure-sensitive adhesive may be utilized to provide the desired adhesive properties. The adhesive agent may be selected to provide either a permanent bond or a releasable bond according to the particular application. A permanent bond requires destruction of the storage wrap and/or the container for access to the contents. Releasable bonds provide access to the contents by permitting separation of the wrap from itself or the container at the bond site without destruction. The releasable bond may additionally be refastenable if sufficient adhesive character remains after the initial activation/bonding/release cycle.

The storage wrap material should be sufficiently flexible to conform readily to any desired surface. The memory or resiliency of the material must be sufficiently small that it does not exert undue restorative forces causing the material to break contact with the container/item/target surface and thus becoming prematurely unsecured or unsealed over time. In one embodiment, the material has greater plasticity than elasticity.

The materials of the present invention exhibit an adhesion sufficient to survive the degree of handling the wrapped item or enclosed container is likely to encounter in use while maintaining the desired level of sealing engagement with the item, with itself, or with the accompanying semi-enclosed container such that preservation of perishable items is ensured.

In one embodiment the material of the present invention is substantially clingless. Suitable methods of measuring and quantifying this cling property are described in ASTM test methods D5458-95 and D3354-89. Test method D5458-95 is useful for measuring cling between two layers of film in both stretched and unstretched conditions, and utilizes a 1 inch wide film strip adhered to a flat film attached to an inclined surface. The force required to remove the film strip from the flat film is measured.

Substantially clingless materials in accordance with the present invention can be produced by proper selection of materials including the avoidance of any significant amount of materials known in the art as “cling additives. Further, additional materials or additives can be incorporated as needed to further reduce, if not eliminate, the tendency of such materials to cling to themselves and other surfaces. Such materials would include anti-static agents, etc.

### SELF'd Web Material

The storage wrap of the present invention is constructed of a structural elastic-like film (SELF) web. The term “web” herein refers to a sheet-like material comprising a single layer of material or a laminate of two or more layers. In other embodiments, additional formation means for deforming a storage wrap into a three-dimensional structure may be used, for example, ring-rolling, “micro-SELF” and “rotary knife aperturing” (RKA).

Each of the four formation means disclosed herein are disclosed as comprising a pair of inter-meshing rolls, typically steel rolls having inter-engaging ridges or teeth and grooves. However, it is contemplated that other means for achieving formation can be utilized, such as the deforming roller and cord arrangement disclosed in US 2005/0140057 published Jun. 30, 2005. Therefore, all disclosure of a pair of rolls herein is considered equivalent to a roll and cord, and a claimed arrangement reciting two inter-meshing rolls is considered equivalent to an inter-meshing roll and cord where a cord functions as the ridges of a mating inter-engaging roll. In one embodiment, the pair of intermeshing rolls of the instant invention can be considered as equivalent to a roll and an inter-meshing element, wherein the inter-meshing element can be another roll, a cord, a plurality of cords, a belt, a pliable web, or straps. Likewise, while the disclosure of four formation means is illustrated herein, other known formation technologies, such as creping, necking/consolidation, corrugating, embossing, button break, hot pin punching, and the like may also be used. The formation processes known as ring-rolling, micro-SELF and RKA are further disclosed in U.S. Patent Publication No. 2008/0217809, which is hereby incorporated by reference herein.

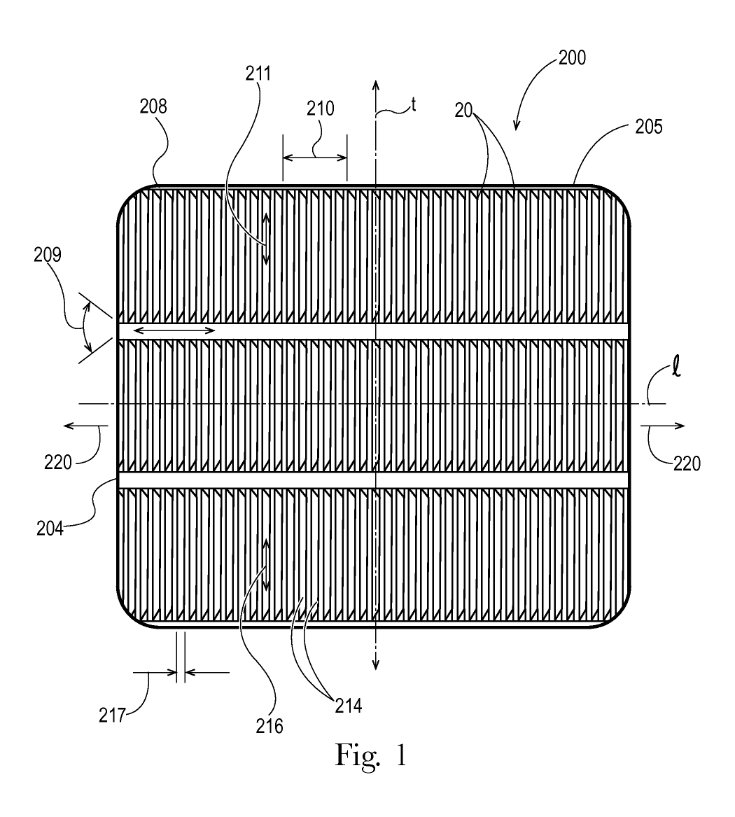

The first formation means for deforming a storage wrap in accordance with the present disclosure is a process commonly referred to as “SELF” or “SELF'ing” process. FIG. 1 shows one embodiment of a SELF web 200 of the present disclosure constructed of a single layer of a formed polymeric material. The SELF web 200 is shown in its untensioned condition. The web has two centerlines, a longitudinal centerline, 1, and a transverse or lateral centerline, t, which is generally perpendicular to the longitudinal centerline. In one embodiment, the web may be comprised substantially of linear low density polyethylene (LLDPE) although it may also be comprised of other polyolefins such as polyethylenes including low density polyethylene (LDPE), ultra low density polyethylene (ULDPE), high density polyethylene (HDPE) or polypropylene and/or blends thereof of the above and other materials. Examples of other suitable polymeric materials include, but are not limited to, polyester, polyurethanes, compostable or biodegradable polymers, and breathable polymers.

The mass density of high-density polyethylene can range from about 0.93 to about 0.97 g/cm³. Although the density of HDPE is only marginally higher than that of LDPE, HDPE has little branching, giving it stronger intermolecular forces and tensile strength than LDPE. The difference in strength exceeds the difference in density, giving HDPE a higher specific strength. It is also harder and more opaque and can withstand somewhat higher temperatures (120° C./248° F. for short periods, 110° C./230° F. continuously). HDPE, unlike polypropylene, cannot withstand normally-required autoclaving conditions. The lack of branching is ensured by an appropriate choice of catalyst (e.g., Ziegler-Natta catalysts) and reaction conditions. HDPE contains the chemical elements carbon and hydrogen.

LDPE is defined by a density range of from about 0.910 to about 0.940 g/cm³. It is not reactive at room temperatures, except by strong oxidizing agents, and some solvents cause swelling. It can withstand temperatures of 80° C. continuously and 95° C. for a short time. Made in translucent or opaque variations, it is quite flexible, and tough but breakable. LDPE has more branching (on about 2% of the carbon atoms) than HDPE, so its intermolecular forces (instantaneous-dipole induced-dipole attraction) are weaker, its tensile strength is lower, and its resilience is higher. Also, since its molecules are less tightly packed and less crystalline because of the side branches, its density is lower. LDPE contains the chemical elements carbon and hydrogen.

LLDPE is a substantially linear polymer (polyethylene), with significant numbers of short branches, commonly made by copolymerization of ethylene with longer-chain olefins. LLDPE differs structurally from conventional LDPE because of the absence of long chain branching. The linearity of LLDPE results from the different manufacturing processes of LLDPE and LDPE. In general, LLDPE is produced at lower temperatures and pressures by copolymerization of ethylene and such higher alpha-olefins as butane, hexane or octane. The copolymerization process produces an LLDPE polymer that has a narrower molecular weight distribution than conventional LDPE and in combination with the linear structure, significantly different rheological properties.

In another embodiment, the web may comprise an extensible polymer at a temperature of from about 0 degrees C. to about 50 degrees C. Extensible polymers include, but are not limited to, polymeric materials that have a percent elongation/strain at break higher than about 50% in the machine direction, and in another embodiment, having a percent elongation/strain at break higher than about 100% and a Young's Modulus less than about 2,500 MPa in the machine direction, in yet another embodiment, having a percent elongation/strain at break higher than about 100% and a Young's Modulus less than about 2,000 MPa in the machine direction, in yet another embodiment, having a percent elongation/strain at break higher than about 100% and a Young's Modulus less than about 1,000 MPa in the machine direction, and in yet another embodiment, having a percent elongation/strain at break higher than about 100% and a Young's Modulus less than about 500 MPa in the machine direction.

The percent elongation/strain at break is the amount of stretch the film underwent before the point of break. Young's Modulus and percent elongation/strain at break can be measured on a tensile test machine using ASTM standard test method D 882—Tensile Testing of Thin Plastic Sheeting.

Examples of storage wrap compositions according to the present disclosure are shown in Table 1.

TABLE 1
Storage Wrap Compositions (weight percent)

| Example | HDPE | | LLDPE | | Thickness | Young's Modulus* | Strain @ Break |
|---|---|---|---|---|---|---|---|
| No. | Grade | (%) | Grade | (%) | (mil) | (MPa) | % |
| 1 | Equistar | 90 | Exxon | 10 | 0.35 | 1494 | 154 |
| | L5005 | | L1001.32 | | | | |
| 2 | Equistar | 90 | LyondellBasell | 10 | 1.10 | 495 | 458 |
| | L5005 | | GA501022 | | | | |
| 3 | Equistar | 90 | LyondellBasell | 10 | 0.70 | 587 | 345 |
| | L5005 | | GA501023 | | | | |
| 4 | Equistar | 90 | LyondellBasell | 10 | 0.35 | 981 | 251 |
| | L5005 | | GA501024 | | | | |
| 5 | Equistar | 80 | LyondellBasell | 20 | 1.10 | 397 | 478 |
| | L5005 | | GA501025 | | | | |
| 6 | Equistar | 80 | LyondellBasell | 20 | 0.70 | 486 | 385 |
| | L5005 | | GA501026 | | | | |
| 7 | Equistar | 80 | LyondellBasell | 20 | 0.35 | 688 | 254 |
| | L5005 | | GA501027 | | | | |
| 8 | Equistar | 70 | LyondellBasell | 30 | 1.10 | 362 | 485 |
| | L5005 | | GA501028 | | | | |
| 9 | Equistar | 70 | LyondellBasell | 30 | 0.7 | 381 | 365 |
| | L5005 | | GA501029 | | | | |
| 10 | Equistar | 70 | LyondellBasell | 30 | 0.35 | 654 | 255 |
| | L5005 | | GA501030 | | | | |
| 11 | Equistar | 60 | LyondellBasell | 40 | 0.7 | 377 | 404 |
| | L5005 | | GA501031 | | | | |
| 12 | Equistar | 60 | LyondellBasell | 40 | 0.35 | 544 | 254 |
| | L5005 | | GA501032 | | | | |
| 13 | Equistar | 50 | LyondellBasell | 50 | 0.7 | 280 | 415 |
| | L5005 | | GA501033 | | | | |
| 14 | Equistar | 50 | LyondellBasell | 50 | 0.35 | 460 | 249 |
| | L5005 | | GA501034 | | | | |
| 15 | Equistar | 70 | Exxon | 30 | 0.7 | 478 | 488 |
| | L5005 | | L3001.32 | | | | |

*Machine Direction

Referring to FIGS. 1 and 1A, the SELF web includes a “strainable network” of distinct regions. As used herein, the term “strainable network” refers to an interconnected and interrelated group of regions which are able to be extended to some useful degree in a predetermined direction providing the SELF web with an elastic-like behavior in response to an applied and subsequently released elongation. The strainable network includes at least a first region 204 and a second region 206. The SELF web 200 includes a transitional region 205 which is at the interface between the first region 204 and the second region 206. The transitional region 205 will similarly exhibit complex combinations of behavior of both the first region and the second region. It is recognized that the various embodiments will have transitional regions, however, the present disclosure is largely defined by the behavior of the web material in the distinctive regions (for example, first region 204 and second region 206). Therefore, the ensuing description of the present disclosure will be concerned with the behavior of the web material in the first regions and the second regions only since it is not significantly dependent upon the complex behavior of the web material in the transitional regions 205.

SELF web 200 has a first surface and an opposing second surface. In one embodiment, as shown in FIGS. 1 and 1A, the strainable network includes a plurality of first regions 204 and a plurality of second regions 206. The first regions 204 have a first axis 208 and a second axis 209, wherein the first axis 208 may be longer than the second axis 209. The first axis 208 of the first region 204 is substantially parallel to the longitudinal axis of the SELF web 200 while the second axis 209 is substantially parallel to the transverse axis of the SELF web 200. In one embodiment, the second axis of the first region, (i.e., the width of the first region), is from about 0.01 inches to about 0.5 inches, and in another embodiment, from about 0.03 inches to about 0.25 inches. The second regions 206 have a first axis 210 and a second axis 211. The first axis 210 is substantially parallel to the longitudinal axis of the SELF web 200, while the second axis 211 is substantially parallel to the transverse axis of the SELF web 200. In another embodiment, the second axis of the second region, (i.e., the width of the second region), is from about 0.01 inches to about 2.0 inches, and in another embodiment, from about 0.125 inches to about 1.0 inches. In the embodiment of FIG. 11, the first regions 204 and the second regions 206 are substantially linear, extending continuously in a direction substantially parallel to the longitudinal axis of the SELF web 200.

The first region 204 has an elastic modulus E1 and a cross-sectional area A1. The second region 206 has an elastic modulus E2 and a cross-sectional area A2.

In the illustrated embodiment, a portion of the SELF web 200 has been “formed” such that the SELF web 200 exhibits a resistive force along an axis, which in the case of the illustrated embodiment is substantially parallel to the longitudinal axis of the SELF web, when subjected to an applied axial elongation in a direction substantially parallel to the longitudinal axis. As used herein, the term “formed” refers to the creation of a desired structure or geometry upon the SELF web that will substantially retain the desired structure or geometry when it is not subjected to any externally applied elongations or forces, i.e. regions of formation. A SELF web of the present disclosure is comprised of at least a first region and a second region, wherein the first region is visually distinct from the second region. As used herein, the term “visually distinct” refers to features of the SELF web material which are readily discernible to the normal naked eye when the SELF web material or objects embodying these SELF web material are subjected to normal use.

Methods for forming SELF web materials include, but are not limited to, embossing by mating plates or rolls, thermoforming, high pressure hydraulic forming, or casting. While the entire portion of the SELF web 200 has been subjected to a forming operation, the present disclosure may also include subjecting to formation only a portion thereof, for example, a portion of a storage wrap.

In one embodiment shown in FIGS. 1 and 1A, the first regions 204 are substantially planar. That is, the material within the first region 204 is in substantially the same condition before and after the formation step undergone by the SELF web 200. The second regions 206 include a plurality of raised rib-like elements 214. The rib-like elements 214 may be embossed, debossed or a combination thereof. The rib-like elements 214 have a first or major axis 216 which is substantially parallel to the transverse axis of the SELF web 200 and a second or minor axis 217 which is substantially parallel to the longitudinal axis of the SELF web 200. The first axis 216 of the rib-like elements 214 is at least equal to, and in one example, longer than the second axis 217. In one embodiment, the ratio of lengths of the first axis 216 to the second axis 217 is at least about 1:1, or greater, and in another embodiment, at least about 2:1 or greater.

The rib-like elements 214 in the second region 216 may be separated from one another by unformed areas, essentially unembossed or debossed, or simply formed as spacing areas. In one embodiment, the rib-like elements 214 are adjacent one another and are separated by an unformed area of less than 0.10 inches as measured perpendicular to the major axis 216 of the rib-like element 214, and in one embodiment, the rib-like element 214 are contiguous having no unformed areas between them.

What makes the SELF web particularly well suited for use as a storage wrap is that it exhibits a modified “Poisson lateral contraction effect” substantially less than that of an otherwise identical unformed web of similar material composition. As used herein, the term “Poisson lateral contraction effect” describes the lateral contraction behavior of a storage wrap material which is being subjected to an applied elongation. The Poisson's Lateral Contraction Effect (PLCE) is calculated using the following formula:

$$P L C E = \frac{\frac{\vert w 2 - w 1}{w 1}}{\frac{\vert l 2 - l 1 \vert}{l 1}}$$

Where w2=The width of the sample under an applied longitudinal elongation
w1=The original width of the sample
l2=The length of the sample under an applied longitudinal elongation
l1=The original length of the sample (gage length)

In one embodiment, the Poisson lateral contraction effect of the SELF web of the present disclosure is less than about 0.8 when the SELF web is subjected to about 25% elongation. In another embodiment, the SELF web exhibits a Poisson lateral contraction effect less than about 1.0 when the SELF web is subjected to about 50 or even 100% elongation. The Poisson lateral contraction effect of the storage wrap of the present disclosure is determined by the amount of the web material which is occupied by the first and second regions, respectively. As the area of the SELF web material occupied by the first region increases, the Poisson lateral contraction effect also increases. Conversely, as the area of the SELF web material occupied by the second region increases the Poisson lateral contraction effect decreases. In one embodiment, the percent area of the SELF web material occupied by the first region is from about 2% to about 90%, and in another embodiment, from about 5% to about 50%.

Web materials of the prior art which have at least one layer of an elastomeric material will generally have a large Poisson lateral contraction effect, i.e., they will “neck down” as they elongate in response to an applied force. SELF web materials of the present disclosure can be designed to moderate if not substantially eliminate the Poisson lateral contraction effect.

For the SELF web 52, the direction of applied axial elongation, D, indicated by arrows 220 in FIG. 1, is substantially perpendicular to the first axis 216 of the rib-like elements 214. The rib-like elements 214 are able to unbend or geometrically deform in a direction substantially perpendicular to their first axis 216 to allow extension in the SELF web 200.

Referring now to FIG. 1B, as the SELF web is subjected to an applied axial elongation, D, indicated by arrows 220 in FIG. 1. The rib-like elements 214 in the second region 206 are experiencing geometric deformation, or unbending, and offer minimal resistance to the applied elongation. As seen in FIG. 1C, the rib-like elements 214 in the second region 206 have become substantially aligned with the axis of applied elongation (i.e., the second region has reached its limit of geometric deformation) and begin to resist further elongation via molecular-level deformation.

When the SELF web is subjected to an applied elongation, the SELF web exhibits an elastic-like behavior as it extends in the direction of applied elongation and returns to its substantially untensioned condition once the applied elongation is removed, unless the SELF web is extended beyond the point of yielding. The SELF web is able to undergo multiple cycles of applied elongation without losing its ability to substantially recover. Accordingly, the SELF web is able to return to its substantially untensioned condition once the applied elongation or force is removed.

While the SELF web may be easily and reversibly extended in the direction of applied axial elongation, in a direction substantially perpendicular to the first axis of the rib-like elements, the SELF web is not as easily extended in a direction substantially parallel to the first axis of the rib-like elements. The formation of the rib-like elements allows the rib-like elements to geometrically deform in a direction substantially perpendicular to the first or major axis of the rib-like elements, while requiring substantially molecular-level deformation to extend in a direction substantially parallel to the first axis of the rib-like elements.

The amount of applied force required to extend the SELF web is dependent upon the composition and cross-sectional area of the web material forming the SELF web and the width and spacing of the first regions, with narrower and more widely spaced first regions requiring lower applied extension forces to achieve the desired elongation. The first axis, (i.e., the length) of the first regions may be greater than the second axis, (i.e., the width) of the first region with a length to width ratio of from about 5:1 or greater.

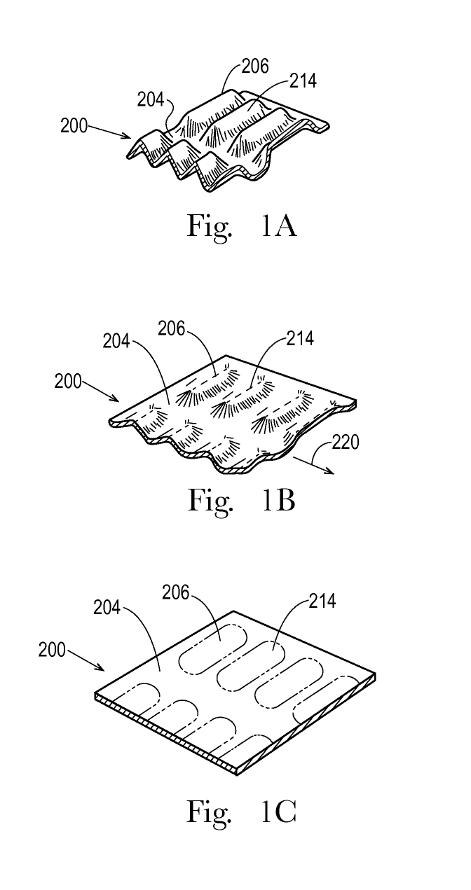

In FIG. 2 there is shown a graph of the resistive force-elongation/strain curve of a SELF storage wrap or web vs. a base storage wrap or web, i.e., not including first and second regions. Specifically, Example No. 15 from Table 1 was used to generate curves 710 (base storage wrap) and 720 (SELF storage wrap). The method for generating the resistive force-elongation/strain curves is ASTM standard test method D 882—Tensile Testing of Thin Plastic Sheeting. The tensile test is performed at room temperature (about 22° C.) using a 2 inch gauge gap for the tesile tester. The sample to be tested is cut into a substantially rectilinear shape, for example, approximately 15 mm wide by approximately 75 mm long. A suitable instrument for this test includes a tensile tester from MTS Systems Corp., Eden Prairie, Minn., for example, Model Synergie 400. The instrument is interfaced with a computer. TestWorks 4™ software controls the testing parameters, performs data acquisition and calculations, and provides graphs and data reports. The comparison of a SELF storage wrap vs. a base storage wrap is shown below in Table 2:

TABLE 2

| | Young's Modulus* | Strain @ Yield |
|---|---|---|
| Example #15 from Table 1 | (MPa) | (%) |
| Base Storage wrap (curve | 478 | 28 |
| 710) | | |
| SELF Storage wrap (curve | 254 | 81 |
| 720) | | |

*Machine Direction

The storage wrap (Example #15 from Table 1) is SELF'd according to a process in which the toothed roll (the top roll) had teeth having a pitch of 0.060 inches, a tooth height of 0.075 inches, and a tooth spacing of 0.060 inches. The corners of the teeth were further rounded. The mating roll (bottom roll) was an un-toothed roll, that is, a roll having circumferentially extending ridges and grooves, similar to that shown in FIG. 19 above, and engaged at a depth of engagement (DOE) of about 0.045 inches. The SELF'ing process was carried out a room temperature at a rate of about 20 ft./min.

This demonstrates that the SELF storage wrap or web exhibits a lower Young's Modulus/higher Strain @ Yield vs. the base storage wrap or web, resulting in a storage wrap that is easier to stretch while maintaining uniform deformation.

Additional comparisons of SELF'd storage wraps vs. base storage wraps according to the present disclosure are shown in Table 3:

TABLE 3
Examples of SELF'd Storage wraps vs. Base Storage wraps

| | | | | Young's Modulus | | Strain @ Yield | | Strain @ Break | |
|---|---|---|---|---|---|---|---|---|---|
| | Example | | Depth of | (MPa) | | (%) | | (%) | |
| Example | No. From | Selfing | Engagement | Base | SELF'd | Base | SELF'd | Base | SELF'd |
| No. | Table 1 | activation | (inch) | Film | Film | Film | Film | Film | Film |
| 1 | # 2 | cd tooling, | 0.045″ | 458 | 219 | 31 | 66 | 495 | 170 |
| | | then rotating | | | | | | | |
| 2 | # 2 | cd tooling, | 0.055″ | 458 | 232 | 31 | 87 | 495 | 102 |
| | | then rotating | | | | | | | |
| 3 | # 5 | cd tooling, | 0.045″ | 478 | 191 | 36 | 59 | 397 | 241 |
| | | then rotating | | | | | | | |
| 4 | # 5 | cd tooling, | 0.055″ | 478 | 188 | 36 | 100 | 397 | 133 |
| | | then rotating | | | | | | | |
| 5 | # 8 | cd tooling, | 0.055″ | 485 | 172 | 37 | 95 | 362 | 217 |
| | | then rotating | | | | | | | |
| 6 | # 3 | cd tooling, | 0.045″ | 345 | 264 | 98 | 139 | 587 | 147 |
| | | then rotating | | | | | | | |
| 7 | # 3 | cd tooling, | 0.055″ | 345 | 261 | 98 | 95 | 587 | 98 |
| | | then rotating | | | | | | | |
| 8 | # 9 | cd tooling, | 0.055″ | 365 | 201 | 97 | 134 | 381 | 139 |
| | | then rotating | | | | | | | |
| 9 | # 11 | cd tooling, | 0.055″ | 404 | 139 | 41 | 228 | 377 | 250 |
| | | then rotating | | | | | | | |
| 10 | # 13 | cd tooling, | 0.055″ | 415 | 146 | 45 | 262 | 280 | 265 |
| | | then rotating | | | | | | | |
| 11 | # 15 | cd tooling, | 0.045″ | 488 | 302 | 28 | 88 | 478 | 178 |
| | | then rotating | | | | | | | |
| 12 | # 15 | md tooling | 0.045″ | 488 | 230 | 28 | 78 | 478 | 290 |

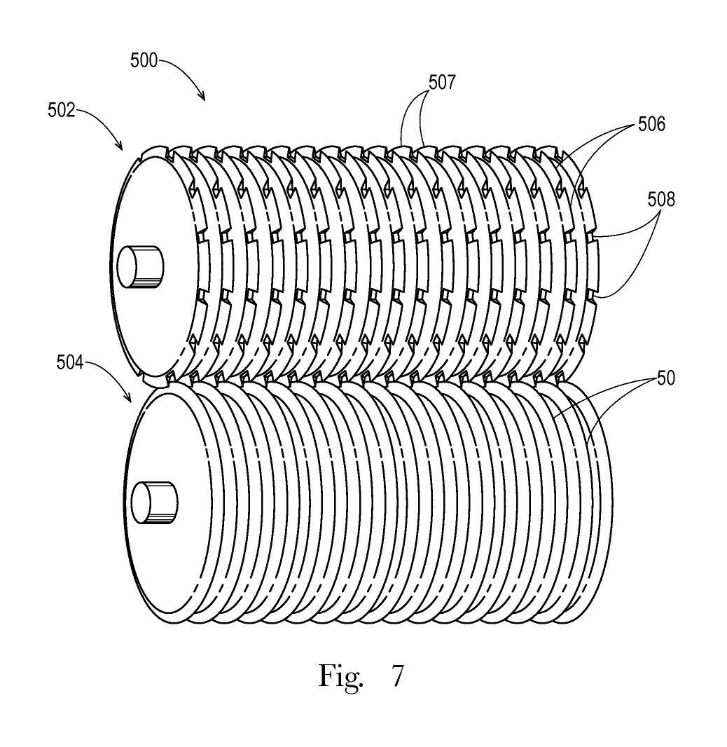

For Example Nos. 1 to 11 in Table 3, the storage wraps are cut layer in machine direction, rotated 90° and then SELF'd with according to a process in which the toothed roll (the top roll) had teeth having a pitch of 0.060 inches, a tooth height of 0.075 inches, and a tooth spacing of 0.060 inches. The corners of the teeth were further rounded. The mating roll (bottom roll) was an un-toothed roll, that is, a roll having circumferentially extending ridges and grooves, similar to that shown in FIG. 7 above, and engaged at a depth of engagement (DOE) listed in Table 3. The SELF'ing process was carried out a room temperature and hand cranked.

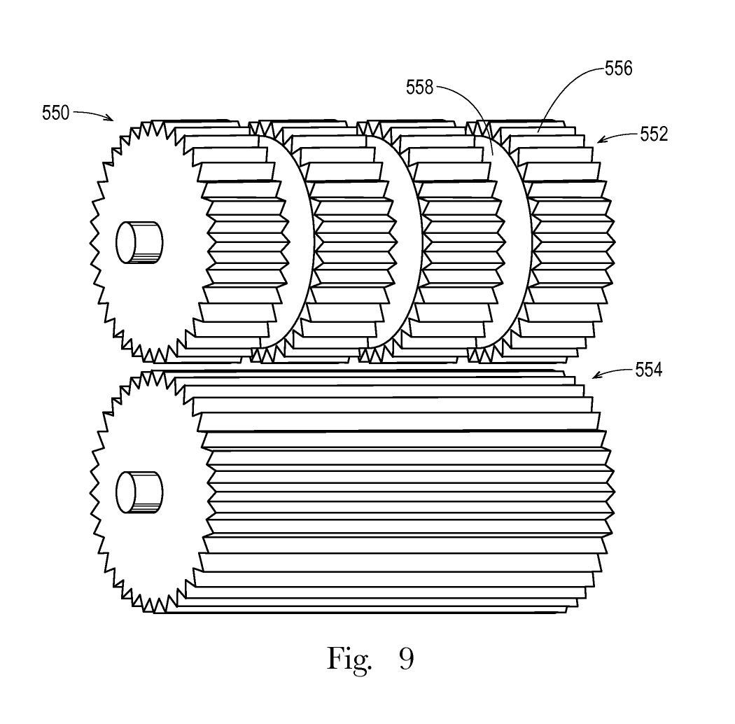

For Example No. 12 in Table 3, the storage wraps are cut layer in machine direction, rotated 90° and then SELF'd with according to a process in which the toothed roll (the top roll) had teeth having a pitch of 0.060 inches, a tooth height of 0.075 inches, and a tooth spacing of 0.060 inches. The corners of the teeth were further rounded. The mating roll (bottom roll) was an un-toothed roll, that is, a roll having circumferentially extending ridges and grooves, similar to that shown in FIG. 9 above, and engaged at a depth of engagement (DOE) of about 0.045 inches. The SELF'ing process was carried out a room temperature at a rate of about 20 ft./min.

As can be seen from Table 3, the depth and frequency of rib-like elements can also be varied to control the available stretch of the SELF web. The available stretch is increased if for a given frequency of rib-like elements, the height or degree of deformation imparted on the rib-like elements is increased. Similarly, the available stretch is increased if for a given height or degree of deformation, the frequency of rib-like elements is increased.

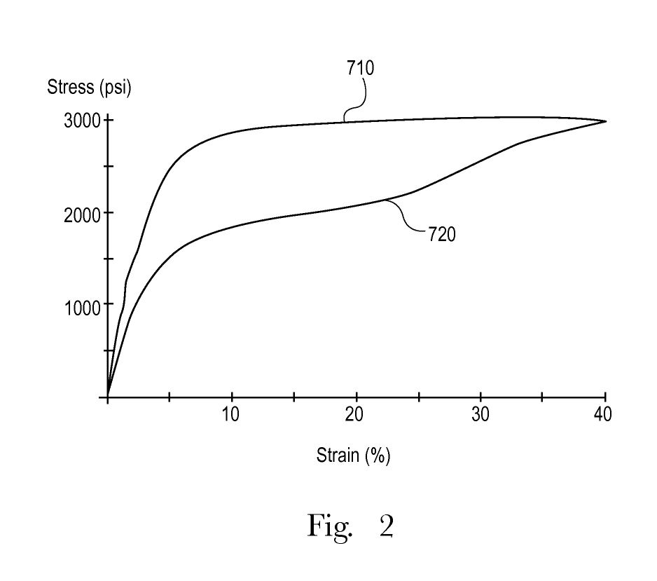

Referring now to FIG. 3, there is shown one example of an apparatus 400 used to form the SELF web 52 shown in FIG. 1. Apparatus 400 includes plates 401, 402. Plates 401, 402 include a plurality of intermeshing teeth 403, 404, respectively. Plates 401, 402 are brought together under pressure to form the base film 406.

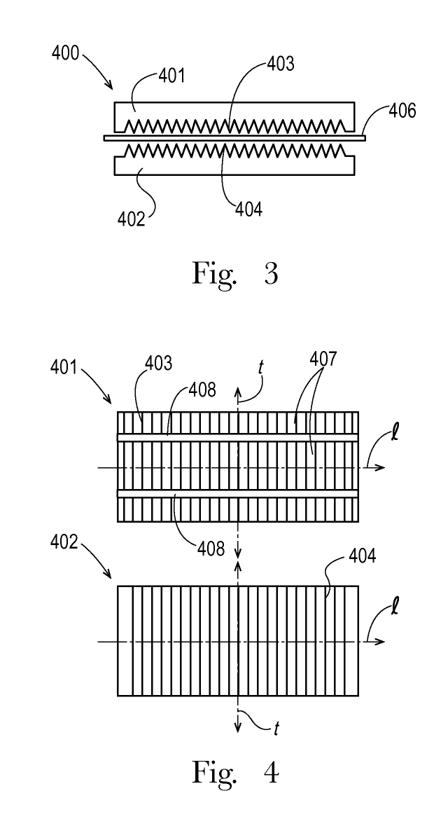

Referring now to FIG. 4, it can be seen that plates 401 and 402 each have a longitudinal axis “1” and a transverse axis “t” which is substantially perpendicular to the longitudinal axis. Plate 401 includes toothed regions 407 and grooved regions 408 both which extend substantially parallel to the longitudinal axis of the plate 401. Within toothed regions 407 of plate 401 there are a plurality of teeth 403. Plate 402 includes teeth 404 which mesh with teeth 403 of plate 401. When the base film 406 is formed between plates 401, 402 the portions of the base film 406 which are positioned within grooved regions 408 of plate 401 and teeth 404 on plate 402 remain undeformed. These regions correspond with the first regions 64 of the SELF web 52 shown in FIG. 1. The portions of the base film 406 positioned between toothed regions 407 of plate 401 and teeth 404 of plate 402 are incrementally and plastically formed creating rib-like elements 74 in the second regions 66 of the SELF web 52.

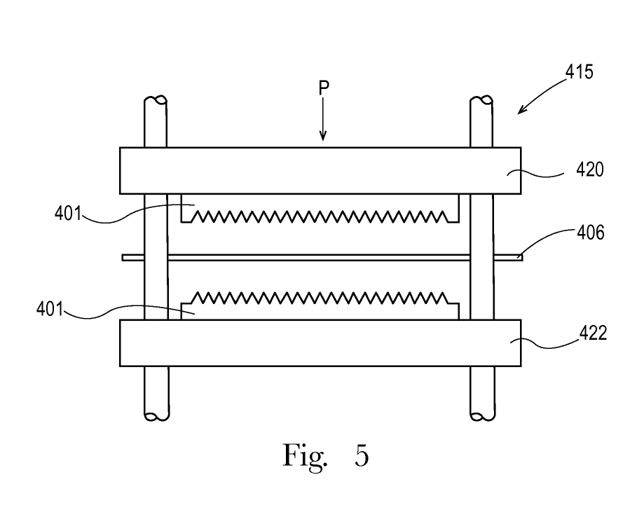

In one embodiment, the method of formation can be accomplished in a static mode, where one discrete portion of a base film is deformed at a time. An example of such a method is shown in FIG. 5. A static press indicated generally as 415 includes an axially moveable plate or member 420 and a stationary plate 422. Plates 401 and 402 are attached to members 420 and 422, respectively. While plates 401 and 402 are separated, base film 406 is introduced between the plates, 401, 402. The plates are then brought together under a pressure indicated generally as “P”. The upper plate 401 is then lifted axially away from plate 402 allowing the formed polymeric web to be removed from between plates 401 and 402.

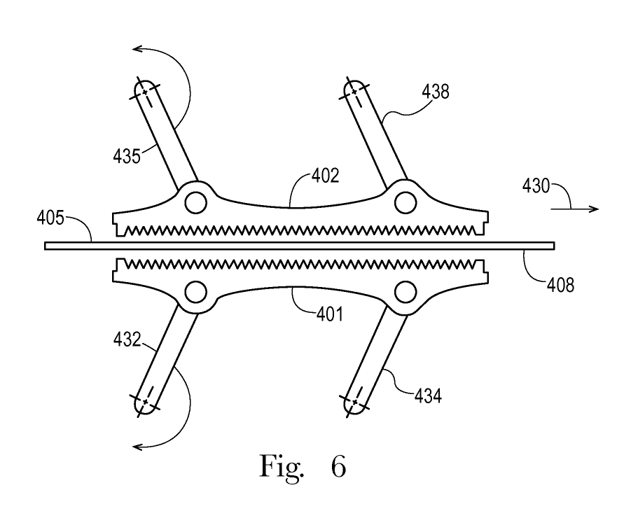

FIG. 6 is an example of a dynamic press for intermittently contacting the moving web and forming the base material 406 into a formed web similar to the SELF web 52 of FIG. 1. Polymeric film 406 is fed between plates 401 and 402 in a direction generally indicated by arrow 430. Plate 401 is secured to a pair of rotatably mounted arms 432, 434 which travel in a clockwise direction which move plate 401 in a similar clockwise motion. Plate 402 is connected to a pair of rotary arms 436, 438 which travel in a counter clockwise direction moving plate 402 in a counter clockwise direction. Thus, as web 406 moves between plates 401 and 402 in direction indicated by arrow 430, a portion of the base film between the plates is formed and then released such that the plates 401 and 402 may come back grab and deform another section of base film 406. This method has the benefit of allowing virtually any pattern of any complexity to be formed in a continuous process, for example, uni-directional, bi-directional, and multi-directional patterns.

The dynamic press of FIG. 6 could be used on a strip of material to form strainable networks into the completed product. For example, the entire or portions of the completed strip of material could be placed between plates 401 and 402 to create a strainable network in all layers of the strip of material.

Another method of forming the base material into a SELF web is vacuum forming. An example of a vacuum forming method is disclosed in commonly assigned U.S. Pat. No. 4,342,314, issued to Radel et al. on Aug. 3, 1982. Alternatively, the SELF web of the present disclosure may be hydraulically formed in accordance with the teachings of commonly assigned U.S. Pat. No. 4,609,518 issued to Curro et al. on Sep. 2, 1986. Each of the above said patents being incorporated herein by reference.

In FIG. 7 there is shown another apparatus generally indicated as 500 for forming the base film into a formed SELF web. Apparatus 500 includes a pair of rolls 502, 504. Roll 502 includes a plurality of toothed regions 506 and a plurality of grooved regions 508 that extend substantially parallel to a longitudinal axis running through the center of the cylindrical roll 502. Toothed regions 506 include a plurality of teeth 507. Roll 504 includes a plurality of teeth 510 which mesh with teeth 507 on roll 502. As a base film is passed between intermeshing rolls 502 and 504, the grooved regions 508 will leave portions of the film undeformed producing the first regions of the SELF web 52 of FIG. 1. The portions of the film passing between toothed regions 506 and teeth 510 will be formed by teeth 507 and 510, respectively, producing rib-like elements in the second regions of the SELF web 52. The embodiment of FIG. 7 is referred to as CD or cross-machine direction SELFing because the web 52 can be stretched in CD direction.

Alternatively, roll 504 may consist of a soft rubber. As the base film is passed between toothed roll 502 and rubber roll 504 the film is mechanically formed into the pattern provided by the toothed roll 502. The film within the grooved regions 508 will remain undeformed, while the film within the toothed regions 506 will be formed producing rib-like elements in the second regions.

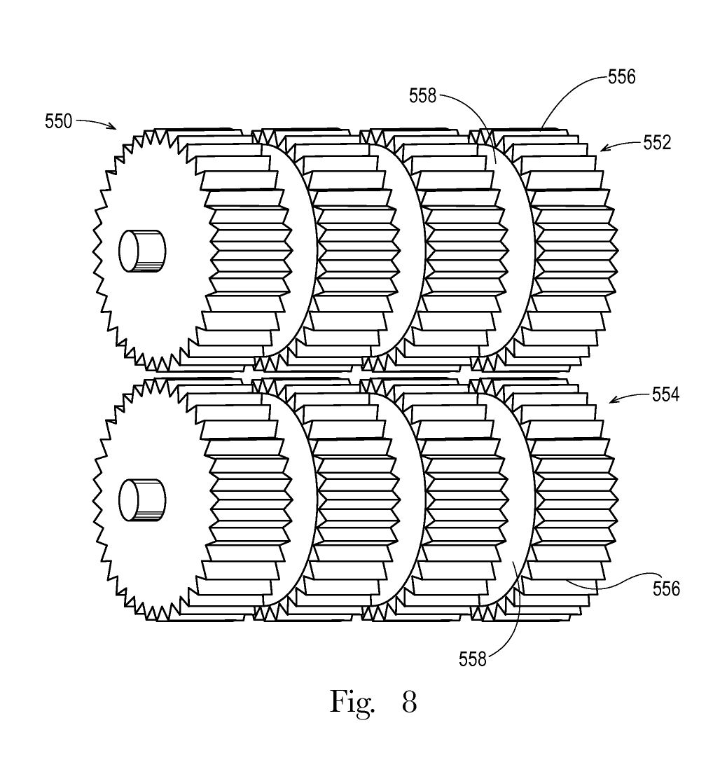

Referring now to FIG. 8, there is shown an alternative apparatus generally indicated as 550 for forming the base film into a SELF web in accordance with the teachings of the present disclosure. Apparatus 550 includes a pair of rolls 552, 554. Rolls 552 and 554 each have a plurality of toothed regions 556 and grooved regions 558 extending about the circumference of rolls 552, 554 respectively. As the base film passes between rolls 552 and 554, the grooved regions 558 will leave portions of the film undeformed, while the portions of the film passing between toothed regions 556 will be formed producing rib-like elements in second regions 66. The embodiment of FIG. 8 is referred to as MD or machine direction SELFing because the web 52 can be stretched in MD direction.

Referring now to FIG. 9, there is shown another embodiment indicated as 600 for forming the base film into a SELF web. Apparatus 600 includes a pair of rolls 652, 654. Roll 652 has a plurality of toothed regions 656 and grooved regions 658 extending about the circumference of roll 652. Roll 654 includes a plurality of teeth 610 which mesh with teeth 656 on roll 652. As the base film passes between rolls 652 and 654, the grooved regions 658 will leave portions of the film undeformed producing the first regions of the SELF web 52 of FIG. 1. The portions of the film passing between the toothed regions 656 and teeth 610 will be formed by teeth 657 and 610, respectively, producing rib-like elements in the second regions of the SELF web 52. The embodiment of FIG. 9 is also referred to as MD or machine direction SELFing because the web 52 can be stretched in MD direction.

The pair of rolls discussed above may include any number of teeth and grooves as desired. In addition, the teeth and grooves may be nonlinear, such as for example, curved, sinusoidal, zig-zag, etc. The size and amount of engagement of teeth and grooves may be of any desired dimensions. In one embodiment, the pitch of the teeth are from about 0.020 inches to about 0.180 inches; in another embodiment from about 0.030 inches to about 0.120 inches; in another embodiment from about 0.040 inches to about 0.100 inches; and in yet another embodiment from about 0.050 inches to about 0.070 inches, or any individual value these ranges.

Storage wrap or web material may be comprised of polyolefins such as polyethylenes, including linear low density polyethylene (LLDPE), low density polyethylene (LDPE), ultra low density polyethylene (ULDPE), high density polyethylene (HDPE), or polypropylene and blends thereof with the above and other materials. Examples of other suitable polymeric materials which may also be used include, but are not limited to, polyester, polyurethanes, compostable or biodegradable polymers, heat shrink polymers, thermoplastic elastomers, metallocene catalyst-based polymers (e.g., INSITE® available from Dow Chemical Company and EXXACT® available from Exxon), and breathable polymers. The web materials may also be comprised of a synthetic woven, synthetic knit, nonwoven, apertured film, macroscopically expanded three-dimensional formed film, absorbent or fibrous absorbent material, foam filled composition or laminates and/or combinations thereof. The nonwovens may be made but not limited to any of the following methods: spunlace, spunbond, meltblown, carded and/or air-through or calender bonded, with a spunlace material with loosely bonded fibers being the preferred embodiment.

While the SELF web has been described as a single base layer of substantially planar polymeric film, other base materials or laminates of materials may also be used. Examples of base materials from which the SELF web can be made include two-dimensional apertured films and macroscopically expanded, three-dimensional, apertured formed films. Examples of macroscopically expanded, three-dimensional, apertured formed films are described in U.S. Pat. No. 3,929,135 issued to Thompson on Dec. 30, 1975; U.S. Pat. No. 4,324,246 issued to Mullane, et al. on Apr. 13, 1982; U.S. Pat. No. 4,342,314 issued to Radel, et al. on Aug. 3, 1982; U.S. Pat. No. 4,463,045 issued to Ahr, et al. on Jul. 31, 1984; and U.S. Pat. No. 5,006,394 issued to Baird on Apr. 9, 1991. Each of these patents are incorporated herein by reference. Examples of other suitable base materials include composite structures or laminates of polymer films, nonwovens, and polymer films and nonwovens. Additional reinforcing elements can also be added for strength and recovery benefits.

In another embodiment, the storage wrap material may be an elastomeric nonwoven substrate or an elastomeric film that does not require selfing. Non-limiting examples of suitable elastomeric materials include thermoplastic elastomers chosen from at least one of styrenic block copolymers, metallocene-catalyzed polyolefins, polyesters, polyurethanes, polyether amides, and combinations thereof. Suitable styrenic block copolymers may be diblock, triblock, tetrablock, or other multi-block copolymers having at least one styrenic block. Example styrenic block copolymers include styrene-butadiene-styrene, styrene-isoprene-styrene, styrene-ethylene/butylenes-styrene, styrene-ethylene/propylene-styrene, and the like. Commercially available styrenic block copolymers include KRATON® from the Shell Chemical Company of Houston, Tex.; SEPTON® from Kuraray America, Inc. of New York, N.Y.; and VECTOR® from Dexco Polymers, LP of Houston, Tex. Commercially available metallocene-catalyzed polyolefins include EXXPOL® and EXACT® from Exxon Chemical Company of Baytown, Tex.; AFFINITY®; and ENGAGE® from Dow Chemical Company of Midland, Mich. Commercially available polyurethanes include ESTANE® from Noveon, Inc., Cleveland, Ohio Commercial available polyether amides include PEBAX® from Atofina Chemicals of Philadelphia, Pa. Commercially available polyesters include HYTREL® from E. I. DuPont de Nemours Co., of Wilmington, Del. Other particularly suitable examples of elastomeric materials include elastomeric polypropylenes. In these materials, propylene represents the majority component of the polymeric backbone, and as a result, any residual crystallinity possesses the characteristics of polypropylene crystals. Residual crystalline entities embedded in the propylene-based elastomeric molecular network may function as physical crosslinks, providing polymeric chain anchoring capabilities that improve the mechanical properties of the elastic network, such as high recovery, low set and low force relaxation. Suitable examples of elastomeric polypropylenes include an elastic random poly(propylene/olefin) copolymer, an isotactic polypropylene containing stereoerrors, an isotactic/atactic polypropylene block copolymer, an isotactic polypropylene/random poly(propylene/olefin) copolymer block copolymer, a reactor blend polypropylene, a very low density polypropylene (or, equivalently, ultra low density polypropylene), a metallocene polypropylene, and combinations thereof. Suitable polypropylene polymers including crystalline isotactic blocks and amorphous atactic blocks are described, for example, in U.S. Pat. Nos. 6,559,262, 6,518,378, and 6,169,151. Suitable isotactic polypropylene with stereoerrors along the polymer chain are described in U.S. Pat. No. 6,555,643 and EP 1 256 594 A1. Suitable examples include elastomeric random copolymers (RCPs) including propylene with a low level comonomer (e.g., ethylene or a higher α-olefin) incorporated into the backbone. Suitable elastomeric RCP materials are available under the names VISTAMAXX® (available from ExxonMobil, Houston, Tex.) and VERSIFY® (available from Dow Chemical, Midland, Mich.).

In another embodiment, the storage wrap material may be formed by a process for selectively aperturing a nonwoven web. In one embodiment, the nonwoven web may be extensible, elastic, or nonelastic. The nonwoven web may be a spunbonded web, a meltblown web, or a bonded carded web. If the nonwoven web is a web of meltblown fibers, it may include meltblown microfibers. The nonwoven web may be made of fiber forming polymers such as, for example, polyolefins. U.S. Pat. No. 5,916,661, entitled “Selectively Apertured Nonwoven Web” issued to Benson et al. on Jun. 29, 1999, discloses a process for selectively aperturing a nonwoven web and is incorporated herein by reference.

In another embodiment, the strip of material may be formed by a substance encapsulation system. U.S. Pat. No. 6,716,498, entitled “Applications For Substance Encapsulating Laminate Web” issued to Curro et al. on Apr. 6, 2004, disclosed a suitable substance application system and is incorporated herein by reference.

Surprisingly, we have found that strips of material with a SELF'd storage wrap can be more easily stretched without causing sudden necking. Rather, the web of material according to the present disclosure is uniformly deformed when it is stretched. These beneficial properties can be quantified by measuring certain characteristics of a strip of material, including Young's Modulus, % Strain @ Break and % Strain @ Yield. Strips of material according to the present disclosure may have a Young's Modulus of less than 50 MPa, in another embodiment less than 40 MPa, in yet another embodiment less than 30 MPa, and in yet another embodiment from about 15 MPa to about 50 MPa. In another embodiment, strips of material according to the present disclosure may have a % Strain @ Break of greater than about 250%, in another embodiment of from about 250% to about 500% and in another embodiment of from about 200% to about 400%. In another embodiment, strips of material according to the present disclosure may have a % Strain @ Yield of greater than about 25%, in another embodiment of from about 20% to about 300%, in another embodiment of from about 25% to about 200%, and in another embodiment of from about 30% to about 100%.

The storage wrap material of the present invention may be transparent or translucent, so that it may be accurately positioned. Micro-texturing the material during forming may also be useful. Micro-texturing may be accomplished, for example, by drawing the piece of material into forming screen recesses and against a micro-textured surface, such as a vacuum drum having tiny apertures therein.

The storage wrap materials of the present invention may be employed to enclose a wide variety of items, both perishable and non-perishable. Such items may include single items within a given container/package system, as well as multiple items of the same or different types. Items enclosed may in fact be containers or packages which are themselves to be enclosed, such as a group of cartons wrapped together upon a pallet, for example. The items may be loosely grouped together within a single chamber within the container, or may be segregated within different chambers or compartments formed by the storage wrap material itself or other features of the container.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A storage wrap, comprising a sheet of non-porous material, wherein the non-porous material includes a strainable network having a first region and a second region formed of substantially the same material composition, the first region providing a first, elastic-like resistive force to an applied axial elongation, and the second region providing a second distinctive resistive force to further applied axial elongation, thereby providing at least two stages of resistive forces in use.

2. A storage wrap, comprising a sheet of non-porous material having an average thickness of from about 0.1 mil to about 5.0 mil, the film including:
a. from about 50% to about 90%, by weight of the film, of high-density polyethylene; and
b. from about 10% to about 50%, by weight of the film, of linear low-density polyethylene.

3. A storage wrap that exhibits a Young's Modulus of less than about 50 MPa, a strain at break of at least about 250%, and a strain at yield of at least about 30%.

4. A storage wrap product comprising the storage wrap material of claim 1 and a dispenser, said material forming a continuous web wound to form a roll of storage wrap material, said roll of storage wrap material being disposed within said dispenser.

5. The storage wrap product of claim 4, further comprising a core disposed within said dispenser, said sheet of material being wound upon said core to form said roll of storage wrap material.

6. The storage wrap product of claim 4, wherein said dispenser includes a severing apparatus.
